(19) United States
(12) Patent Application Publication
(10) Pub. No.: US 2011/0142156 A1
(43) Pub. Date: Jun. 16, 2011

(54) MULTI-CHANNEL SIGNALING

(75) Inventor: Jacobus Cornelis HAARTSEN, Hardenberg (NL)

(73) Assignee: SONY ERICSSON MOBILE COMMUNICATIONS AB, Lund (SE)

(21) Appl. No.: 12/638,332

(22) Filed: Dec. 15, 2009

(51) Int. Cl. H04L 27/14

(52) U.S. Cl. 375/271; 375/324

(57) ABSTRACT

A system includes a transmitter device that includes a transmitter baseband controller to segment a bit stream into a first segment, a second segment, and a third segment, and generate a first baseband signal that includes the first segment, a second baseband signal that includes the second segment, and a third baseband signal that includes the third segment; and a radio frequency (RF) transmitter to generate a multi-frequency signal based on the first baseband signal, the second baseband signal, and the third baseband signal; and a receiver device that includes an RF receiver to receive the multi-frequency signal, and retrieve the first baseband signal, the second baseband signal, and the third baseband signal from the received multi-frequency signal; and a receiver baseband control to reassemble the bit stream from the received first baseband signal, the received second baseband signal, and the received third baseband signal.

### BACKGROUND

Wireless communication between electronic devices is widespread and has many applications. For example, short range wireless systems may be used for low-rate sensor systems or for remote control applications. Such short range wireless systems may use the 2.4 GHz Industrial, Scientific, and Medical (ISM) band. Since the opening of the 2.4 GHz band for commercial applications, many communication systems that use the 2.4 GHZ band have been proposed. Examples of systems that use the 2.4 GHz band include systems communicating using the WLAN 802.11 set of standards and systems using Bluetooth protocols, both of which may use spread spectrum techniques. Spread spectrum techniques generate a signal which is spread in the frequency domain. Spread spectrum techniques may increase signal robustness.

Further examples of systems using the 2.4 GHz band include systems using standards set by the ZigBee alliance, which was established for sensor and low-data applications. The physical and datalink (i.e., media access control (MAC)) layers of the ZigBee alliance have been standardized by the IEEE 802.15.4 group. The same physical and datalink layer standards have also been adopted by the RF4CE alliance for remote control of consumer electronic devices, such as televisions and stereo sets. Another system related to Bluetooth, known as Bluetooth Low Energy (LE), also know as Ultra Low Power (ULP), has been introduced for use with low-data rate sensor systems and remote control applications.

The RF4CE specifications (now also controlled by the ZigBee alliance) only define three frequencies from which to select. A first frequency is in the middle of the 2.4 GHz band, a second frequency is in the lower edges of the 2.4 GHz band, and a third frequency is in the higher edges of the 2.4 GHz band. Bluetooth LE, similar to conventional Bluetooth, applies frequency hopping through the entire 2.4 GHz, but only after a connection has been established. For connection establishment, three dedicated advertisement frequencies are used. A first frequency is in the middle of the 2.4 GHz band, a second frequency is at the lower edges of the 2.4 GHz band, and a third frequency is at the higher edges of the 2.4 GHz band. The use of three frequencies for connection advertisement in both RF4CE and Bluetooth LE may provide protection from interference. If one frequency is blocked (e.g., by interference caused by a WLAN transmitter in the vicinity), the system may jump to another one of the three frequencies if interference is detected.

Systems using the WLAN 802.11 set of standards, systems using Bluetooth protocols, and systems using the 802.15.4 physical layer standard may not take into account multi-path fading. Multi-path fading may refer to signal attenuation due to the presence of reflectors in the environment that create multiple paths that a signal may traverse. A receiver receives, via the multiple paths, a superposition of multiple copies of the signal, which may lead to creative or destructive interference of the signal. Thus, despite the availability of various short-range wireless communication techniques, achieving effective signal transmission may continue to be particularly challenging.

### SUMMARY

According to one aspect, a system may include a receiver device that includes a radio frequency (RF) receiver to receive a multi-frequency signal, and retrieve a plurality of baseband signals from the received multi-frequency signal, where each of the plurality of baseband signals is associated with a different frequency; and a baseband controller to receive the plurality of baseband signals and reassemble a bit stream of information from the plurality of baseband signals.

Additionally, the multi-frequency signal may include a first signal at a carrier frequency minus an intermediate frequency (IF), a second signal at the carrier frequency, and a third signal at the carrier frequency plus the IF.

Additionally, the RF receiver may be further to retrieve the first signal at the IF, retrieve an in-phase component and a quadrature component of the second signal, and retrieve the third signal at the IF.

Additionally, the RF receiver may be to split the received multi-frequency signal into a first branch signal and a second branch signal, and the RF receiver may include a first mixer to mix the first branch signal with a cosine signal at the carrier frequency, a second mixer to mix the second branch signal with a sine signal at the carrier frequency, a first shifter to shift the mixed first branch signal; a second shifter to shift the mixed second branch signal; a first summer to sum the shifted first branch signal and an un-shifted second branch signal to retrieve the first signal; and a second summer to sum the shifted second branch signal and an un-shifted first branch signal to retrieve the third signal.

Additionally, the RF receiver may be further to retrieve an in-phase component of the second signal from the mixed first branch signal, and retrieve a quadrature component of the second signal from the mixed second branch signal.

Additionally, the baseband controller may be to determine a measure of quality for a particular one of the plurality of baseband signals and reject the particular one of the plurality of baseband signals if the measure of quality of the particular one of the plurality of baseband signals is below a particular threshold.

Additionally, the plurality of baseband signals may include a bit stream of information, a particular one of the plurality of baseband signals may include a section of the bit stream of information, and another one of the plurality of baseband signals may include a different section of the bit stream of information.

Additionally, the baseband controller may be to receive a subsequent plurality of baseband signals that includes the bit stream of information, and the subsequent plurality of baseband signals may include a different arrangement of bits of the bit stream of information.

Additionally, the system may further include a transmitter device that includes another baseband controller to segment information to be transmitted into a plurality of segments, generate a first plurality of transmission baseband signals that includes the plurality of segments, where a particular one of the plurality of first transmission baseband signals includes a particular one of the plurality of segments, generate a second plurality of transmission baseband signals that includes the plurality of segments, where an arrangement of the plurality of segments included in the second plurality of transmission baseband signals differs from an arrangement of the plurality of segments includes in the first plurality of transmission baseband signals.

Additionally, the transmitter device may further include an RF transmitter to generate a first transmission multi-frequency signal from the first plurality of transmission baseband signals and a second transmission multi-frequency signal from the second plurality of transmission baseband signals.

Additionally, the RF transmitter may include a first shifter to shift a first transmission IF signal; a second shifter to shift a second transmission IF signal; a first summer to sum the shifted first transmission IF signal, an un-shifted second transmission IF signal, and a quadrature component of a second baseband signal to generate a first summed signal; a first mixer to mix the first summed signal with a sine carrier frequency signal; a second summer to sum the shifted second transmission IF signal, an un-shifted first transmission IF signal, and an in-phase component of the second baseband signal to generate a second summed signal; a second mixer to mix the second summed signal with a cosine carrier frequency signal; and a third summer to sum the mixed first summed signal with the mixed second summed signal to generate the first transmission multi-frequency signal.

Additionally, the receiver device may be to send an acknowledgement signal to the transmitter device in response to receiving the information.

According to another aspect, a method, performed by a radio frequency receiver device, may include receiving a multi-frequency signal; retrieving a plurality of baseband signals from the received multi-frequency signal; retrieving particular segments of bits from particular ones of the plurality of baseband signals; and reassembling a bit stream of information from the retrieved segments of bits.

Additionally, the multi-frequency signal may include a first signal at a carrier frequency minus an intermediate frequency (IF), a second signal at the carrier frequency, and a third signal at the carrier frequency plus the IF.

Additionally, retrieving a plurality of baseband signals from the received multi-frequency signal may include retrieving the first signal at the IF, retrieving an in-phase component and a quadrature component of the second signal, and retrieving the third signal at the IF.

Additionally, retrieving a plurality of baseband signals from the received multi-frequency signal may include splitting the received multi-frequency signal into a first branch signal and a second branch signal; mixing the first branch signal with a cosine signal at a carrier frequency, mixing the second branch signal with a sine signal at the carrier frequency; shifting the mixed first branch signal; shifting the mixed second branch signal; summing the shifted first branch signal and an un-shifted second branch signal to retrieve a first signal; and summing the shifted second branch signal and an un-shifted first branch signal to retrieve a third signal.

Additionally, the method may include retrieving an in-phase component of a second signal from the mixed first branch signal, and retrieving a quadrature component of the second signal from the mixed second branch signal.

Additionally, reassembling the bit stream of information may include determining a quality of a particular one of the plurality of baseband signals; and rejecting the particular one of the plurality of baseband signals, if the determined quality is below a particular threshold.

Additionally, the method may include transmitting an acknowledgement signal to a transmitter device, indicating that the bit stream of information was received.

According to yet another aspect, a system may include a transmitter device that includes a transmitter baseband controller to segment a bit stream into a first segment, a second segment, and a third segment, and generate a first baseband signal that includes the first segment, a second baseband signal that includes the second segment, and a third baseband signal that includes the third segment; and a radio frequency (RF) transmitter to generate a multi-frequency signal based on the first baseband signal, the second baseband signal, and the third baseband signal; and a receiver device that includes an RF receiver to receive the multi-frequency signal, and retrieve the first baseband signal, the second baseband signal, and the third baseband signal from the received multi-frequency signal; and a receiver baseband control to reassemble the bit stream from the received first baseband signal, the received second baseband signal, and the received third baseband signal.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 is a diagram of an exemplary system according to an implementation described herein;

FIG. 2 is a diagram of exemplary signals according to an implementation described herein;

FIG. 3 is a diagram of an exemplary bit stream pattern according to an implementation described herein;

FIG. 4 is a diagram illustrating exemplary components of transmitter 110 or receiver 130 of FIG. 1;

FIG. 5 is a diagram of exemplary components of baseband controller of FIG. 4 implemented in the transmitter of FIG. 1;

FIGS. 6A-6C are diagrams of exemplary components of an RF transmitter according to an implementation described herein;

FIGS. 7A-7C are diagrams of exemplary components of an RF receiver according to an implementation described herein;

FIG. 8 is a diagram of exemplary components of baseband controller of FIG. 4 implemented in the receiver of FIG. 1;

FIGS. 9A and 9B illustrate exemplary method of providing acknowledgement signals according to an implementation described herein;

FIG. 10 illustrates a flow graph of an exemplary process of generating a bit stream pattern from a bit stream;

FIG. 11 illustrates a flow graph of an exemplary process for transmitting a signal;

FIG. 12 illustrates a flow graph of an exemplary process for receiving a signal;

FIG. 13 illustrates a flow graph of a first exemplary process for reassemblying a bit stream from a received signal and

FIG. 14 illustrates a flow graph of a second exemplary process for reassemblying a bit stream from a received signal.

### DETAILED DESCRIPTION

The following detailed description refers to the accompanying drawings. The same reference numbers in different drawings identify the same or similar elements. Also, the following detailed description does not limit the invention.

Short-range radio systems, such as systems for wireless sensor networks and remote control applications may make use of three dedicated frequencies for connection establishment. For example, the Bluetooth LE standard has defined three advertisement frequencies, namely at 2402 MHz, 2426 MHz, and 2480 MHz. Initial connection setup may be achieved via one of these advertisement frequencies. Similarly, the RF4CE specification (now embedded into the ZigBee alliance), uses the frequencies of 2425 MHz, 2450 MHz, and 2475 MHz for connection setup and data traffic. Thus, in systems, such as Bluetooth LE systems or RF4CE systems, the use of three frequencies was selected to overcome interference.

Transmitters and receivers in Bluetooth LE systems or RF4CE systems may only be tuned to a single frequency at a time. If multi-path fading exists for that single frequency, the receiver may not receive a sufficient signal and the communication link may fail. This may mean that no connection can be established or maintained. Dynamic channel allocation, meaning that both transmitter and receiver will seek out an available channel, may be cumbersome, as no communication may exist between the transmitter and the receiver.

Exemplary implementations described herein may relate to radio systems that use multiple frequencies to transmit a signal. A bit stream of information may be transmitted over the multiple frequencies, such that the bit stream is transmitted fully on each frequency, but with the stream of bits arranged in a different order on each frequency. For example, a transmitter may send three bit streams that follow an interweaving pattern using three different frequencies. The bit stream may be sent in segments, where each segment includes the whole bit stream, and subsequent segments may include the whole bit stream in a differently arranged pattern.

If a receiver receives signals at all three frequencies with a high signal to noise ratio (SNR), the receiver may be able to reconstruct the information from the first segment. Suppose the signal at one of the frequencies was weak and the receiver was unable to retrieve the bits at that frequency. The receiver may need to wait to receive the next segment to receive the missing bits.

The receiver may send an acknowledgement signal to the transmitter to inform the transmitter about how much information was received. For example, the receiver may send the acknowledgement signal if all the information was successfully received. If the transmitter receives the acknowledgement signal, the transmitter may not need to transmit further segments and may proceed to transmit a subsequent bit stream. This may allow information to be transmitted in a shorter amount of time.

### Exemplary Devices

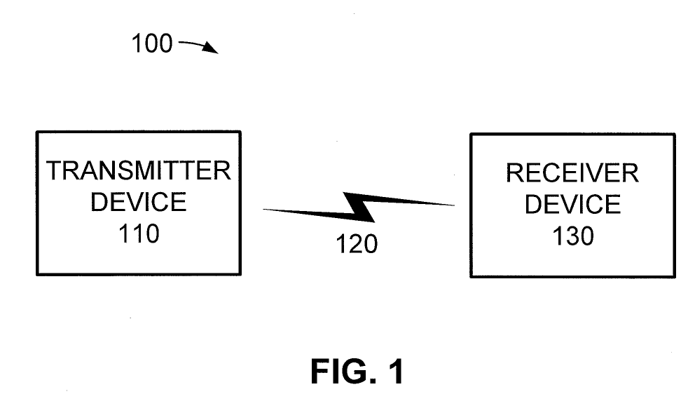

FIG. 1 is a diagram of an exemplary system 100 according to an implementation described herein. System 100 may include a transmitter device 110, signals 120, and a receiver device 130. Transmitter device 110 may include any one or more devices capable of transmitting signals. Transmitter device 110 may include, for example, any electronic device with a communication function (e.g., enabled with short range radio technology), such as, for example, a media playing device with wireless communication capabilities, such as an audio system, a speaker, an earpiece, or a headset with multiple earpieces; a remote control or a device that may be controlled via a remote control; a sensor, such as, for example, a temperature sensor, light sensor, motion sensor, sound sensor, or chemical sensor; a wireless microphone, camera, or video recorder; a desktop computing device, such as a personal computer or a workstation; a laptop or palmtop computer; a mobile telephone or a personal communications system (PCS) terminal that may combine a cellular radiotelephone with data processing, facsimile and data communications capabilities; a personal digital assistant (PDA) or smart phone that may include a radiotelephone, pager, Internet/Intranet access, Web browser, organizer, calendar and/or a global positioning system (GPS) receiver; a networking device, such as a router, switch, firewall, or a gateway; a telephone terminal; a printer; or any other electronic device with a wireless communication function, or combinations thereof.

Transmitter device 110 may send signals 120 to receiver device 130. Signals 120 may include wireless electromagnetic signal carrying information at multiple frequencies. Signals 120 may include, for example, RF signals at three equally spaced frequencies.

Receiver device 130 may include, for example, any electronic device with a communication function (e.g., enabled with short range radio technology), such as, for example, a media playing device with wireless communication capabilities, such as an audio system, a speaker, an earpiece, or a headset with multiple earpieces; a remote control or a device that may be controlled via a remote control; a sensor, such as, for example, a temperature sensor, light sensor, motion sensor, sound sensor, or chemical sensor; a wireless microphone, camera, or video recorder; a desktop computing device, such as a personal computer or a workstation; a laptop or palmtop computer; a mobile telephone or a personal communications system (PCS) terminal that may combine a cellular radiotelephone with data processing, facsimile and data communications capabilities; a personal digital assistant (PDA) or smart phone that may include a radiotelephone, pager, Internet/Intranet access, Web browser, organizer, calendar and/or a global positioning system (GPS) receiver; a networking device, such as a router, switch, firewall, or a gateway; a telephone terminal; a printer; or any other electronic device with a wireless communication function, or combinations thereof.

Transmitter device 110 and receiver device 130 may include a same type of device or group of devices. Alternatively, transmitter device 110 may include one or more devices that are different from receiver device 130. Although FIG. 1 shows exemplary components of system 100, in other implementations, system 100 may contain fewer, different, additional, or differently arranged devices than depicted in FIG. 1. In still other implementations, one or more devices of system 100 may perform one or more other tasks described as being performed by one or more other devices of network 100.

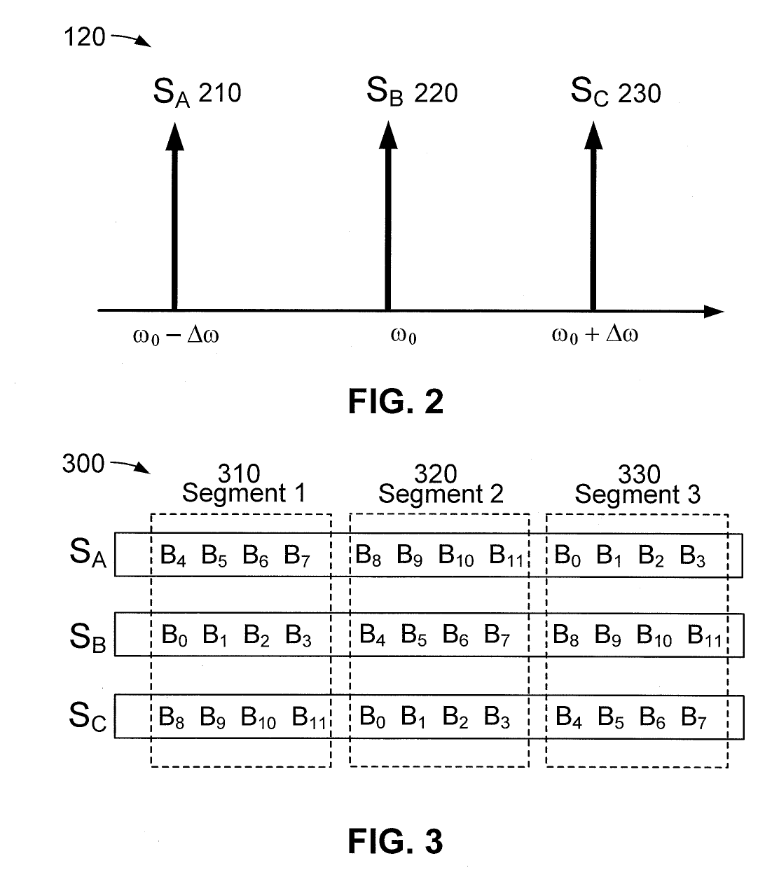

FIG. 2 illustrates an exemplary implementation of signals 120. Signals 120 may include signals transmitted simultaneously over multiple frequencies. In a particular implementation, signals 120 may include signals sent simultaneously at three different frequencies. For example, signals 120 may include a first signal S_{A} 210 sent at a first frequency, a second signal S_{B} 220 sent at second frequency, and a third signal S_{C} 230 sent at a third frequency. The three frequencies may be spaced at an equal distance, where the first frequency includes a carrier frequency minus an intermediate frequency (IF) (ω₀−Δω); where the second frequency includes the carrier frequency (ω₀); and where the third frequency includes the carrier frequency plus the IF (ω₀+Δω). For example, ω₀ may be set to 2450 MHz and Δω (also referred to herein as ω_{IF}) may be set to 25 MHz, leading to a first frequency of 2425 MHz, a second frequency of 2450 MHz, and a third frequency of 2475 MHz.

Although FIG. 2 shows an exemplary implementation of signals 120, in other implementations, signals 120 may contain fewer, different, additional, or differently arranged frequencies than depicted in FIG. 2.

FIG. 3 is a diagram of an exemplary bit stream pattern 300 according to an implementation described herein. Assume a message comprising 12 bits B₀-B₁₁ is to be transmitted. The transmitter may send a first segment 310 that includes the 12 bits in a first pattern, where each frequency is carrying 4 bits of the 12 bits; followed by a second segment 320 that includes the 12 bits in a second pattern, with each frequency carrying 4 bits of the 12 bits; followed by a third segment 330 that includes the bits in a third pattern, with each frequency carrying 4 bits of the 12 bits.

For example, in first segment 310, signal S_{A} 210 at the first frequency may carry bits B₄-B₇, signal S_{B} 220 at the second frequency may carry bits B₀-B₃, and signal S_{C} 230 at the third frequency may carry bits B₈-B₁₁. In second segment 320, bit stream pattern 300 may be rotated, so that signal S_{A} 210 at the first frequency may carry bits B₈-B₁₁, signal S_{B} 220 at the second frequency may carry bits B₄-B₇, and signal S_{C} 230 at the third frequency may carry bits B₀-B₃. In third segment 330, bit stream pattern may be again rotated, so that signal S_{A} 210 at the first frequency may carry bits B₀-B₃, signal S_{B} 220 at the second frequency may carry bits B₈-B₁₁, and signal S_{C} 230 at the third frequency may carry bits B₄-B₇. Thus, any particular frequency will transmit all 12 bits in three segments, yet all 12 bits are transmitted in each segment.

Thus, if receiver device 130 receives all three frequencies at a high SNR, receiver device 130 may receive the entire message in one segment. Assume that the SNR on second signal S_{B} 220 is low and the receiver missed bits B₀-B₃ during first segment 310. However, these bits may be received in second segment 320 via third signal S_{C} 230. Thus, the entire message may be collected after two segments. Assume that the SNR of both second signal S_{B} 220 and third signal S_{C} 230 is low. Then all three segments on first signal S_{A} 210 may need to be received to collect the entire message. Thus, any combination of two good signal streams may provide the message within two segments (i.e., first segment 310 and second segment 320), whereas any single stream may provide the message within three segments.

Existing systems that may be able to receive only one frequency at a time may be able to retrieve the entire message from second signal S_{B} 220, as second signal S_{B} 220 may include the bits of the message in original order. Thus, bit stream pattern 300 may be backwards compatible with existing systems using single frequency receivers.

Although FIG. 3 shows an exemplary bit stream pattern 300, in other implementations, bit stream pattern 300 may contain fewer, different, additional, or differently arranged segments and/or bit arrangements of a bit stream than depicted in FIG. 3. For example, while FIG. 3 illustrates a bit stream of 12 bits divided into segments of 4 bits each, a different number of bits may be used for the bit stream and the bit stream may be divided into segments having a different number of bits each. Furthermore, particular segments may include different numbers of bits.

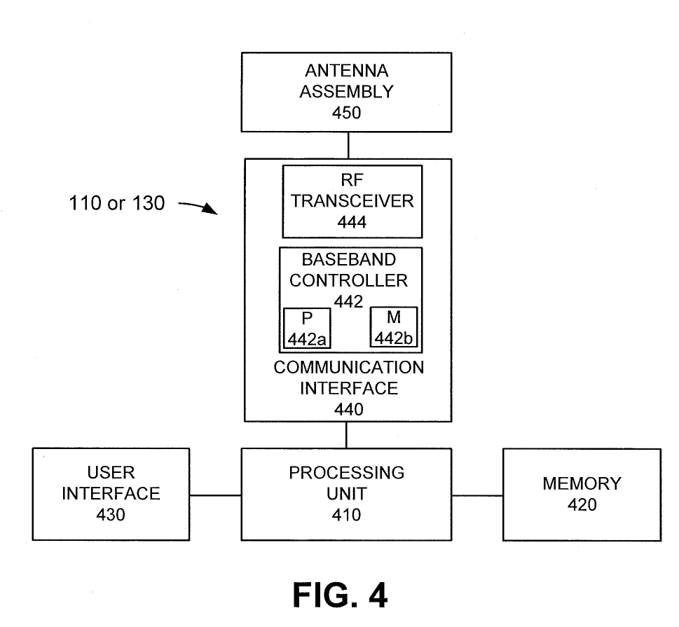

FIG. 4 is a diagram illustrating exemplary components of either transmitter device 110 or receiver device 130. Transmitter device 110 or receiver device 130 may include a processing unit 410, a memory 420, a user interface 430, a communication interface 440, and an antenna assembly 450.

Processing unit 410 may include one or more processors, microprocessors, application specific integrated circuits (ASICs), field programmable gate arrays (FPGAs), or other types of processors that may interpret and execute instructions, programs, or data structures. Processing unit 410 may control operation of communication device 300 and its components.

Memory 420 may include a random access memory (RAM) or another type of dynamic storage device that may store information and/or instructions for execution by processing unit 410; a read only memory (ROM) or another type of static storage device that may store static information and/or instructions for use by processing unit 410; a flash memory (e.g., an electrically erasable programmable read only memory (EEPROM)) device for storing information and/or instructions; and/or some other type of magnetic or optical recording medium and its corresponding drive.

User interface 430 may include mechanisms for inputting information to transmitter device 110 or receiver device 130 and/or for outputting information from transmitter device 110 or receiver device 130. Examples of input and output mechanisms might include a speaker to receive electrical signals and output audio signals; a camera lens to receive image and/or video signals and output electrical signals; a microphone to receive audio signals and output electrical signals; buttons (e.g., a joystick, control buttons, or keys of a keypad) to permit data and control commands to be input into transmitter device 110 or receiver device 130; a display (e.g., a touch screen) to output visual information; and/or a vibrator to cause transmitter device 110 or receiver device 130 to vibrate.

Communication interface 440 may include any transceiver-like mechanism that enables transmitter device 110 or receiver device 130 to communicate with other devices and/or systems. For example, communication interface 440 may include a modem or an Ethernet interface to a local area network (LAN). In one implementation, for example, communication interface 340 may communicate with a network (e.g., a local area network (LAN), a wide area network (WAN), a telephone network, such as the Public Switched Telephone Network (PSTN), an intranet, the Internet, or a combination of networks).

Communication interface 440 may also include mechanisms for communicating via a wireless network. For example, communication interface 440 may include baseband controller 442 and radio frequency (RF) transceiver 444.

Baseband controller 442 may receive signals from a particular component of transmitter device 110 or receiver device 130, prepare the signals for transmission, and provide the prepared signal to RF transceiver 444. Baseband controller 442 may receive signals from RF transceiver 444, prepare the signals for use by a particular component of transmitter device 110 or receiver device 130, and provide the prepared signal to the particular component. Baseband controller 442 may, for example, perform modulation and demodulation of signals. Baseband controller 442 may be part of communication interface 440 or may be a separate integrated circuit. Baseband controller 442 may include a baseband processor 442a and a baseband memory 442b.

Baseband processor 442a may include one or more processors, microprocessors, ASIC, FPGA, or other types of processors that may interpret and execute instructions, programs, or data structures. Baseband processor 442a may control operation of baseband controller 442 and its components.

Baseband memory 442b may include a RAM or another type of dynamic storage device that may store information and/or instructions for execution by baseband processor 442a; a ROM or another type of static storage device that may store static information and/or instructions for use by baseband processor 442a; a flash memory (e.g., an electrically erasable programmable read only memory (EEPROM)) device for storing information and/or instructions; and/or some other type of magnetic or optical recording medium and its corresponding drive.

RF transceiver 444 may include a transmitter that may convert baseband signals from baseband controller 442 to radio frequency (RF) signals and/or a receiver that may convert RF signals to baseband signals. Alternatively, RF transceiver 444 may include a transceiver to perform functions of both a transmitter and a receiver. RF transceiver 444 may connect to antenna assembly 450 for transmission and/or reception of the RF signals.

Antenna assembly 450 may include one or more antennas to transmit and/or receive RF signals over the air. Antenna assembly 450 may, for example, receive RF signals from RF transceiver 444 and transmit them over the air and receive RF signals over the air and provide them to RF transceiver 444.

As described herein, transmitter device 110 or receiver device 130 may perform certain operations in response to processing unit 410 (and/or baseband processor 442a) executing software instructions contained in a computer-readable medium, such as memory 420 (and/or baseband memory 442b). A computer-readable medium may be defined as a physical or logical memory device. A logical memory device may include memory space within a single physical memory device or spread across multiple physical memory devices. The software instructions may be read into memory 420 (and/or baseband memory 442b) from another computer-readable medium or from another device via communication interface 440. The software instructions contained in memory 420 (and/or baseband memory 442b) may cause processing unit 410 (and/or baseband processor 442a) to perform processes that will be described later. Alternatively, hardwired circuitry may be used in place of or in combination with software instructions to implement processes described herein. Thus, implementations described herein are not limited to any specific combination of hardware circuitry and software.

Although FIG. 4 shows exemplary components of transmitter device 110 or receiver device 130, in other implementations, transmitter device 110 or receiver device 130 may contain fewer, different, additional, or differently arranged components than depicted in FIG. 4. In still other implementations, one or more components of transmitter device 110 or receiver device 130 may perform one or more other tasks described as being performed by one or more other components of transmitter device 110 or receiver device 130.

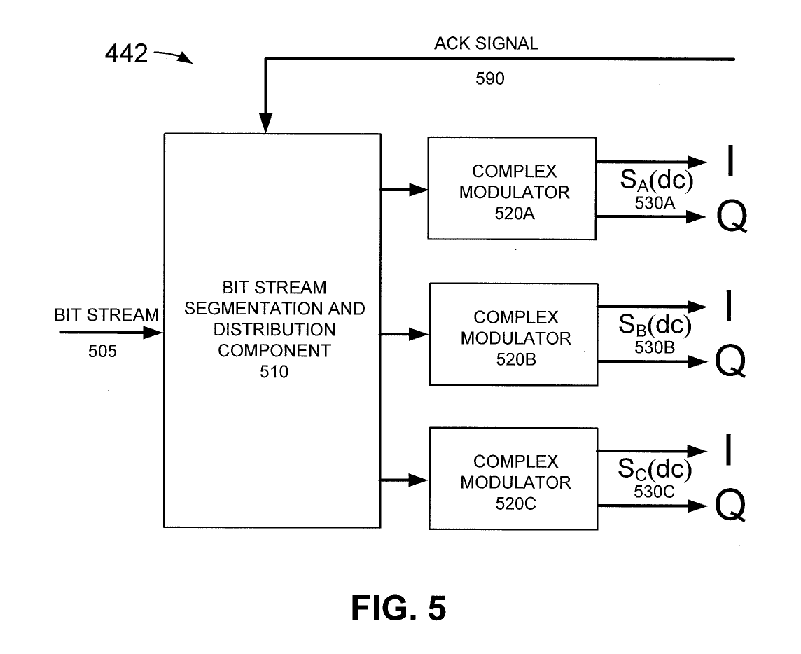

FIG. 5 is a diagram of exemplary components of baseband controller 442 of FIG. 4 implemented in transmitter 110. Baseband controller 442 of transmitter device 110 may include a bit stream segmentation and distribution component 510, and one or more complex modulators 520A-520C.

Bit stream segmentation and distribution component 510 may receive bit stream 505 and may divide bit stream 505 into segments. For example, bit stream 505 may include 12 bits and may be divided into three segments of four bits each. Bit stream segmentation and distribution component 510 may distribute the segments into multiple signals. For example, bit stream segmentation and distribution component 510 may provide each segment to be transmitted as a separate signal. Bit stream segmentation and distribution component 510 may subsequently rotate or permute the segments and provide the segments in a different arrangement to be transmitted as separate signals. In one implementation, bit stream segmentation and distribution component 510 may store bit stream 505 in a temporary register and may use pointers to read segments of the bit stream from the temporary register. One pointer may be assigned per signal and the pointers may be rotated after each segment has been transmitted.

In one implementation, bit stream segmentation and distribution component 510 may include a header, with each segment, that includes information about the order of bits in the transmitted segments. The information in the headers may be used by receiver device 130 to reassemble bit stream 505 in the correct order. In another implementation, information about the order of bits in the segments that are to be transmitted may be provided using a different method. For example, a control data unit with the information about the order of the bits may be sent when a connection between transmitter device 110 and receiver device 130 is being established.

Bit stream segmentation and distribution component 510 may receive acknowledgement signal 590 from receiver device 130. In one implementation, acknowledgement signal 590 may inform bit stream segmentation and distribution component 510 that bit stream 505 was received. In another implementation, acknowledgement signal 590 may inform bit stream segmentation and distribution component 510 about which signals and/or which segments of bit stream 505 were received. In response to receiving acknowledgement signal 590, bit stream segmentation and distribution component 510 may adjust the output of segments that are provided to complex modulators 520A-520C. For example, bit stream segmentation and distribution component 510 may determine that entire bit stream 505 was received and may proceed to processing a subsequent bit stream.

Complex modulators 520A-520C may receive bit stream segments from bit stream segmentation and distribution component 510 and may use complex modulation to generate modulated baseband signals. For example, complex modulators 520A-520C may use quadratic amplitude modulation (QAM) to generate in-phase (I) and quadrature (Q) components of modulated baseband signals. For example, complex modulator 520A may generate I and Q components of first baseband signal S_{A} 530A, complex modulator 520B may generate I and Q components of second baseband signal S_{B} 530B, and complex modulator 520C may generate I and Q components of third baseband signal S_{C} 530C.

Although FIG. 5 shows exemplary components of baseband controller 442 of transmitter device 110, in other implementations, baseband controller 442 of transmitter device 110 may contain fewer, different, additional, or differently arranged components than depicted in FIG. 5. In still other implementations, one or more components of baseband controller 442 of transmitter device 110 may perform one or more other tasks described as being performed by one or more other components of baseband controller 442 of transmitter device 110.

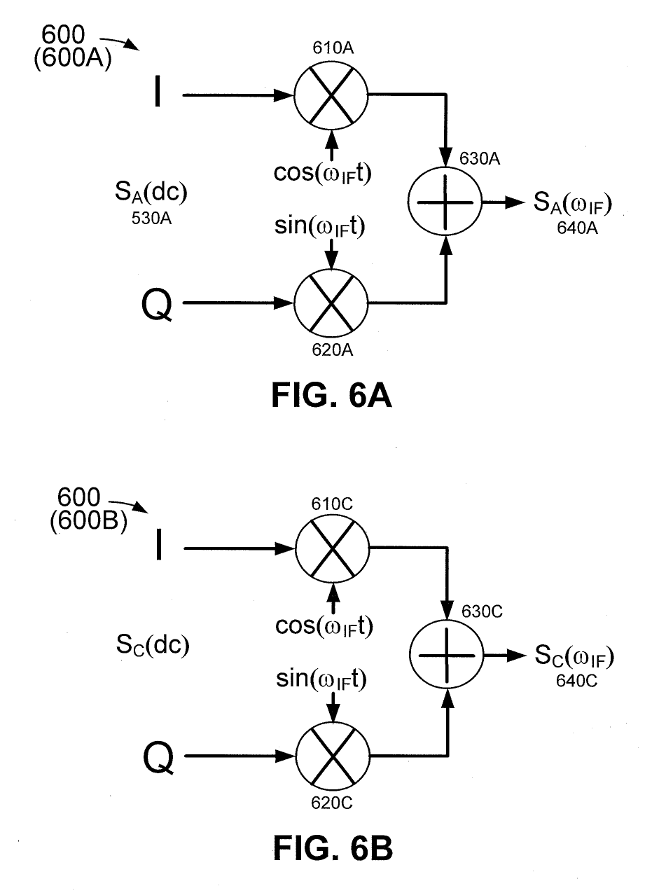

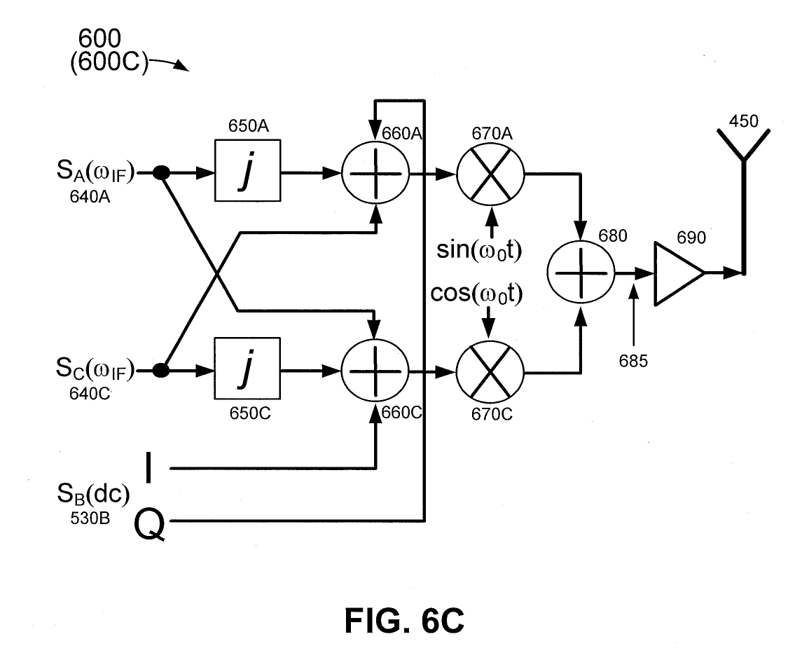

FIGS. 6A-6C are diagrams illustrating exemplary components of an RF transmitter 600 according to an implementation described herein. RF transmitter 600 may be implemented, for example, in RF transceiver 444 of transmitter device 110. RF transmitter 600 may include a first IF transmitter section 600A, a second IF transmitter section 600B, and an RF transmitter section 600C.

First IF transmitter section 600A may include a cosine mixer 610A, a sine mixer 620A, and a summer 630A. Cosine mixer 610A may receive the I component of first baseband signal S_{A} 530A and mix (i.e., multiply) the I component of first baseband signal S_{A} 530A with cos(ω_{IF}t). Sine mixer 620A may receive the Q component of first baseband signal S_{A} 530A and mix (i.e., multiply) the Q component of first baseband signal S_{A} 530A with sin(ω_{IF}t). Summer 630A may sum (i.e., add) the resulting two signals, generating a complex signal that has been up-converted to IF. First IF transmitter section 600A may provide first IF signal S_{A}(ω_{IF}) 640A to RF transmitter section 600C.

Second IF transmitter section 600B may include a cosine mixer 610C, a sine mixer 620C, and a summer 630C. Cosine mixer 610C may receive the I component of third baseband signal S_{C} 530C and mix (i.e., multiply) the I component of third baseband signal S_{C} 530C with cos(ω_{IF}t). Sine mixer 620C may receive the Q component of third baseband signal S_{C} 530C and mix (i.e., multiply) the Q component of third baseband signal S_{C} 530C with sin(ω_{IF}t). Summer 630C may sum (i.e., add) the resulting two signals, generating a complex signal that has been up-converted to IF. Second IF transmitter section 600B may provide second IF signal S_{C}(ω_{IF}) 640C to RF transmitter section 600C.

RF transmitter section 600C may include a first shifter 650A, a second shifter 650C, a first summer 660A, a second summer 660C, a sine mixer 670A, a cosine mixer 670C, a third summer 680, a power amplifier 690, and may be connected to antenna assembly 450.

First shifter 650A may shift first IF signal S_{A}(ω_{IF}) 640A by 90 degrees (i.e., by π/2) to change the phase of first IF signal S_{A}(ω_{IF}) 640A. First summer 660A may sum shifted first IF signal S_{A}(ω_{IF}) 640A with un-shifted second IF signal S_{C}(ω_{IF}) 640C and with the Q component of second baseband signal S_{B} 530B. Sine mixer 670A may mix the output of first summer 660A with sin(ω₀t) to up-convert the signal to the carrier frequency (i.e., ω₀).

Similarly, second shifter 650C may shift second IF signal S_{C}(ω_{IF}) 640C by 90 degrees (i.e., by π/2) to change the phase of second IF signal S_{C}(ω_{IF}) 640C. Second summer 660C may sum shifted second IF signal S_{C}(ω_{IF}) 640C with un-shifted first IF signal S_{A}(ω_{IF}) 640A and with the I component of second baseband signal S_{B} 530B. Cosine mixer 670C may mix the output of second summer 660C with cos(ω₀t) to up-convert the signal to the carrier frequency (i.e., ω₀).

Third summer 680 may sum the outputs of sine mixer 670A and cosine mixer 670C to generate combined multi-frequency signal 685. Combined multi-frequency signal 685 may be amplified by power amplifier 690 and transmitted by antenna assembly 450.

Although FIG. 6 shows exemplary components of RF transmitter 600, in other implementations, RF transmitter 600 may contain fewer, different, additional, or differently arranged components than depicted in FIG. 6. In still other implementations, one or more components of RF transmitter 600 may perform one or more other tasks described as being performed by one or more other components of RF transmitter 600.

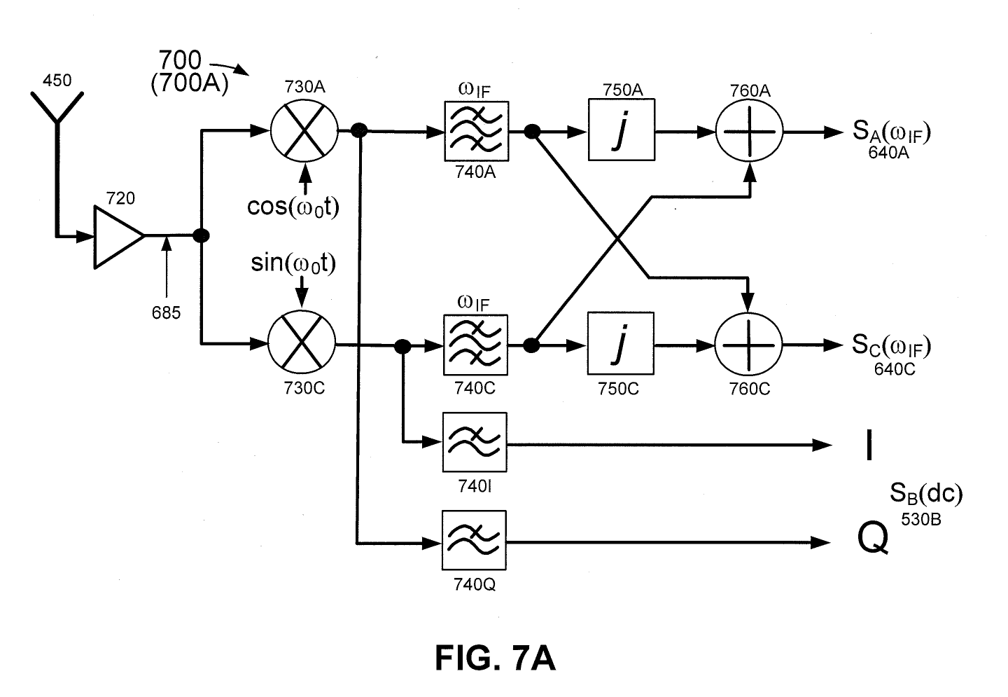

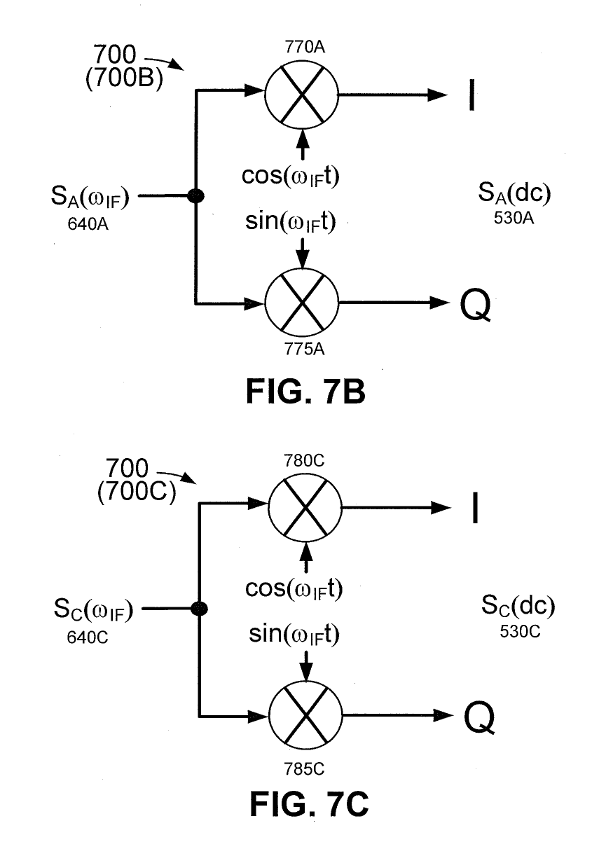

FIGS. 7A-7C are diagrams illustrating exemplary components of an RF receiver 700 according to an implementation described herein. RF receiver 700 may be implemented, for example, in RF transceiver 444 of receiver device 130. RF receiver 700 may include an RF receiver section 700A (FIG. 7A), a first IF receiver section 700B (FIG. 7B), and a second IF receiver section 700C (FIG. 7C).

RF receiver section 700A may be connected to antenna assembly 450 and may include power amplifier 720, a cosine mixer 730A, a sine mixer 730C, a first filter 740A, a second filter 740C, a first shifter 750A, a second shifter 750C, a first summer 760A, a second summer 760C, a third filter 7401, and a fourth filter 740Q. Antenna assembly 450 may receive combined multi-frequency signal 685, which may be amplified by power amplifier 720. The amplified signal may be provided to cosine mixer 730A and sine mixer 730C.

Cosine mixer 730A may receive combined multi-frequency signal 685 and mix combined multi-frequency signal 685 with cos(ω₀t). The signal may then be provided to first filter 740A and to third filter 7401. First filter 740A may include a band-pass filter that may reject higher harmonics of the mixed signal generated by cosine mixer 730A. First shifter 750A may receive the filtered signal and shift the signal by 90 degrees to change the phase of the filtered signal. The shifted signal may be provided to first summer 760A.

Sine mixer 730C may receive combined multi-frequency signal 685 and mix combined multi-frequency signal 685 with sin(ω₀t). The signal may then be provided to second filter 740C and to fourth filter 740Q. Second filter 740C may include a band-pass filter that may reject higher harmonics of the mixed signal generated by sine mixer 730C. Second shifter 750C may receive the filtered signal and shift the signal by 90 degrees to change the phase of the filtered signal. The shifted signal may be provided to second summer 760C.

First summer 760A may sum the shifted signal from first shifter 750A and filtered signal from second filter 740C, which has not been shifted, to retrieve first IF signal S_{A}(ω_{IF}) 640A. Second summer 760C may sum the shifted signal from second shifter 750C and filtered signal from first filter 740A, which has not been shifted, to retrieve second IF signal S_{C}(ω_{IF}) 640A.

Third filter 7401 may include a low-pass filter that may reject higher frequency components of the mixed signal generated by cosine mixer 730A to retrieve the I component of second baseband signal S_{B} 530B. Fourth filter 740Q may include a low-pass filter that may reject higher frequency components of the mixed signal generated by sine mixer 730C to retrieve the Q component of second baseband signal S_{B} 530B.

First IF receiver section 700B may include cosine mixer 770A and sine mixer 775A. Cosine mixer 770A may receive first IF signal S_{A}(ω_{IF}) 640A and mix first IF signal S_{A}(ω_{IF}) 640 with cos(ω_{IF}t) to retrieve the I component of first baseband signal S_{A} 530A. Sine mixer 775A may receive first IF signal S_{A}(ω_{IF}) 640A and mix first IF signal S_{A}(ω_{IF}) 640 with sin(ω_{IF}t) to retrieve the Q component of first baseband signal S_{A} 530A.

Second IF receiver section 700C may include cosine mixer 780C and sine mixer 785C. Cosine mixer 780C may receive second IF signal S_{C}(ω_{IF}) 640C and mix second IF signal S_{C}(ω_{IF}) 640 with cos(ω_{IF}t) to retrieve the I component of third baseband signal S_{C} 530C. Sine mixer 785C may receive second IF signal S_{C}(ω_{IF}) 640C and mix second IF signal S_{C}(ω_{IF}) 640 with sin(ω_{IF}t) to retrieve the Q component of third baseband signal S_{C} 530C.

In an alternative implementation (not shown), first baseband signal S_{A} 530A and third baseband signal S_{C} 530C may be derived by direct IF demodulation of IF signals S_{A}(ω_{IF}) 640A and S_{C}(ω_{IF}) 640C, respectively.

Although FIG. 7 shows exemplary components of RF receiver 700, in other implementations, RF receiver 700 may contain fewer, different, additional, or differently arranged components than depicted in FIG. 7. In still other implementations, one or more components of RF receiver 700 may perform one or more other tasks described as being performed by one or more other components of RF receiver 700.

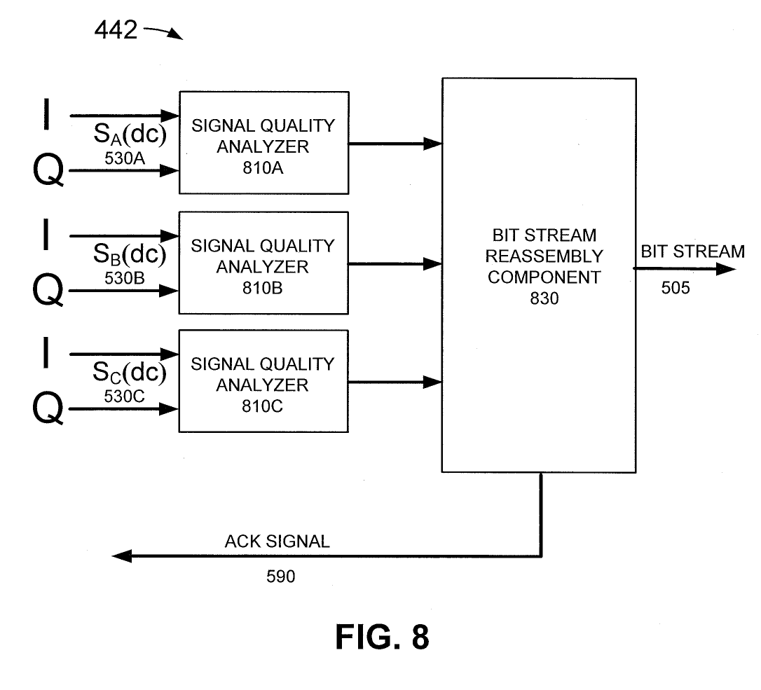

FIG. 8 is a diagram of exemplary components of baseband controller 442 of FIG. 4 implemented in receiver 130. Baseband controller 442 of receiver 130 may include one or more signal quality analyzers 810A-810C and a bit stream re-assembly component 830.

Signal quality analyzer 810A may receive the I and Q components of first baseband signal 530A and determine a quality of first baseband signal 530A. For example, signal quality analyzer 810A may calculate a SNR value for first baseband signal 530A. Signal quality analyzer 810A may accept or reject first baseband signal 530A based on the determined quality. If signal quality analyzer 810A accepts first baseband signal 530A, signal quality analyzer 810A may provide first baseband signal 530A

Signal quality analyzer 810B may receive the I and Q components of second baseband signal 530B and determine a quality of second baseband signal 530B. For example, signal quality analyzer 810B may calculate a SNR value for second baseband signal 530B. Signal quality analyzer 810B may accept or reject second baseband signal 530B based on the determined quality. If signal quality analyzer 810B accepts second baseband signal 530B, signal quality analyzer 810B may provide second baseband signal 530B.

Signal quality analyzer 810C may receive the I and Q components of third baseband signal 530C and determine a quality of third baseband signal 530C. For example, signal quality analyzer 810C may calculate a SNR value for third baseband signal 530C. Signal quality analyzer 810C may accept or reject third baseband signal 530C based on the determined quality. If signal quality analyzer 810C accepts third baseband signal 530C, signal quality analyzer 810C may provide third baseband signal 530C.

Bit stream reassembly component 830 may receive accepted baseband signals and reassemble bit stream 505 from the segments sent via the accepted baseband signals. Bit stream reassembly component 830 may retrieve information about the order of bits from headers included in the segments transmitted by transmitter device 110 and use the information to arrange retrieved segments to reassemble bit stream 505. In one implementation, bit stream reassembly component 830 may store retrieved segments of bit stream 505 in a temporary register based on the order information. When bit stream 505 has been reassembled, bit stream reassembly component 830 may provide reassembled bit stream 505 to another component of transmitter device 110.

Bit stream reassembly component 830 may provide acknowledgement signal 590 for transmission to transmitter device 110. In one implementation, bit stream reassembly component 830 may generate acknowledgement signal 590 after bit stream 505 has been reassembled in entirety. In another implementation, bit stream reassembly component 830 may generate acknowledgement signal 590 after each segment has been received.

Although FIG. 8 shows exemplary components of baseband controller 442 of receiver 130, in other implementations, baseband controller 442 of receiver 130 may contain fewer, different, additional, or differently arranged components than depicted in FIG. 8. In still other implementations, one or more components of baseband controller 442 of receiver 130 may perform one or more other tasks described as being performed by one or more other components of baseband controller 442 of receiver 130.

For example, in another implementation, signal quality analyzers 810A-810C may determine the quality of first IF signal S_{A} 640A and second IF signal S_{C} 640C rather than first baseband signal 530A and third baseband signal 530C, before first IF signal S_{A} 640A and second IF signal S_{C} 640C are down-converted to first baseband signal 530A and third baseband signal 530C.

As another example, in yet another implementation, signal quality analyzers 810A-810C may not be implemented. Rather, quality assessment of signals may be performed after data from all parts of the segment (e.g., all three signals) are stored and combined to assemble a complete message. In such an implementation, bit stream reassembly component 830 may perform a data check, such as a cyclic redundancy check (CRC) on the combined data to determine whether the complete message has been received. If the complete message has not been received, bit stream reassembly component 830 may wait for a next segment and attempt to reassemble the complete message using combinations of the stored data and the newly received data from the next segment. Additionally, bit stream reassembly component may perform forward error checking (FEC) to correct errors in the data.

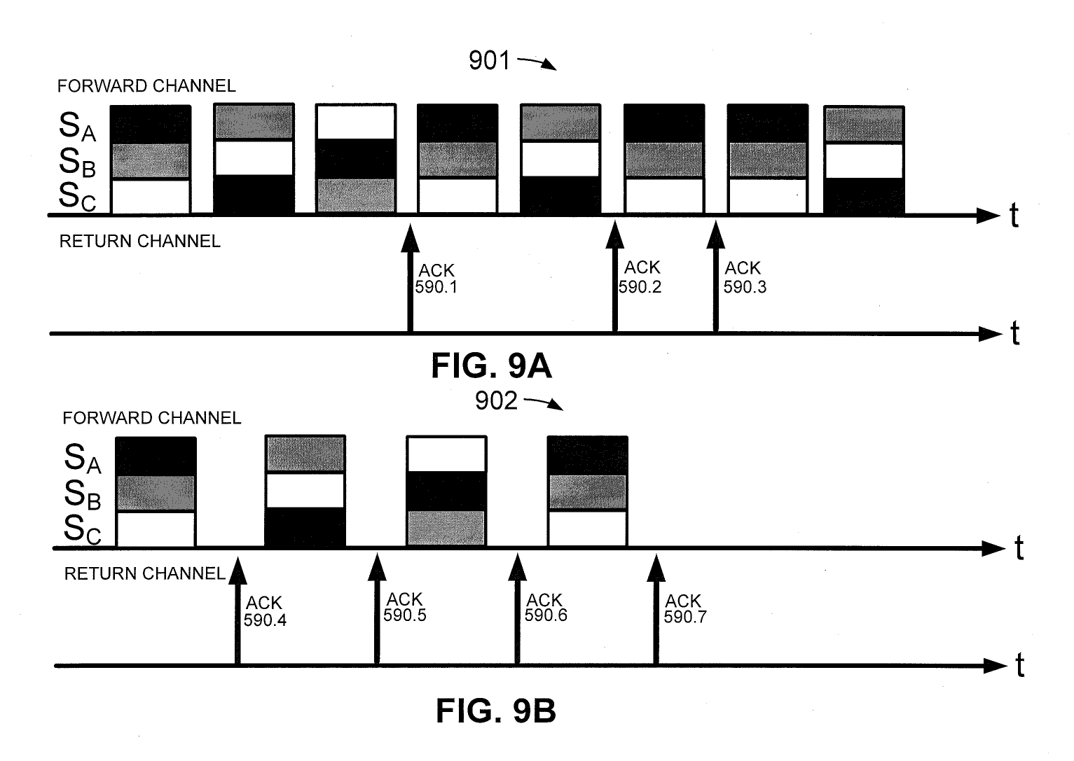

FIGS. 9A and 9B illustrate an exemplary method of providing acknowledgement signals according to an implementation described herein. In the implementation illustrated in FIG. 9A, acknowledgement signal 590 is provided when all segments of a bit stream are received (i.e., all the information has been received). For example, assume that at first, only a single signal at one frequency is being received (e.g., S_{B}), because of multi-path fading in the environment. Bit stream and reassembly component 830 may need to receive three segments to reconstruct bit stream 505 and may send acknowledgement signal 590.1 after three segments have been received. Further assume that receiver 130 is next able to receive two signals. For example, receiver 130 may move within the environment and interference for one of the frequencies that was being blocked may be reduced. Bit stream and reassembly component 830 may be able to reconstruct bit stream 505 from two segments and may send acknowledgement signal 590.2 after two segments have been received. Assume further still that receiver 130 is next able to receive all three signals, for example, due to another change in the environment. Bit stream and reassembly component 830 may be able to reconstruct bit stream 505 from a single segment and may send acknowledgement signal 590.3 after a single segment been received.

In the implementation illustrated in FIG. 9B, acknowledgement signal 590 is provided after each segment. Thus, bit stream and reassembly component 830 may send acknowledgement signals 590.4-590.7 after each segment. In the implementation of FIG. 9B, acknowledgement signal 590 may include information indicating how many signals are being received and/or which signals are being received.

Although FIGS. 9A-9B show exemplary methods of providing acknowledgement signals 590, in other implementations, acknowledgement signals 590 may be provided using fewer, different, additional, or differently arranged intervals than depicted in FIGS. 9A-9B.

### Exemplary Processes

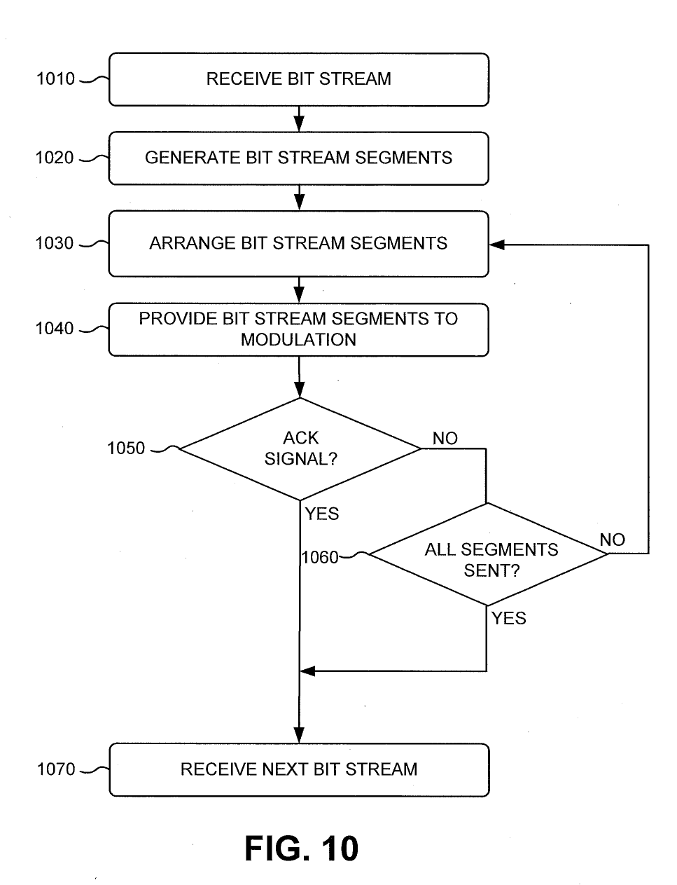

FIG. 10 illustrates a flow graph of an exemplary process of generating a bit stream pattern from a bit stream. In one implementation, the process of FIG. 10 may be performed by baseband controller 442 of transmitter device 110. In other implementations, some or all of the process of FIG. 10 may be performed by another device or a group of devices.

The process of FIG. 10 may include receiving a bit stream (block 1010). For example, bit stream segmentation and distribution component 510 may receive bit stream 505 from another component of transmitter device 110. Bit stream segments may be generated (block 1020). For example, bit stream segmentation and distribution component 510 may generate first segment 310, second segment 320, and third segment 330 from bit stream 505.

Bit stream segments may be arranged (block 1030). For example, bit stream segmentation and distribution component 510 may assign bits B₄-B₇ to first signal S_{A} 210, bits B₀-B₃ to second signal S_{B} 220, and bits B₈-B₁₁ to third signal S_{C} 230.

Arranged bit stream segments may be provided for modulation (block 1040). For example, bit stream segmentation and distribution component 510 may provide bits B₄-B₇ to first complex modulator 520A, bits B₀-B₃ to second complex modulator 520B, and bits B₈-B₁₁ to third complex modulator 520C.

A determination may be made whether an acknowledgement signal was received (block 1050). For example, bit stream segmentation and distribution component 510 may determine whether acknowledgement signal 590 was received from receiver device 130. If an acknowledgement signal was received (block 1050—yes), no further segments may need to be sent and processing may continue with receiving a next bit stream (block 1070). For example, bit stream segmentation and distribution component 510 may receive the next set of 12 bits in the information that is to be transmitted.

If an acknowledgement signal was not received (block 1050—no), a determination may be made whether all segments have been sent (block 1060). For example, bit stream segmentation and distribution component 510 may determine whether first segment 310, second segment 320, and third segment 330 have all been sent. If all segments have been sent (block 1060—yes), no further segments may need to be sent and processing may continue with receiving a next bit stream (block 1070).

If all segments have not been sent (block 1060—no), processing may return to arrange bit stream segments (block 1030). For example, bits of segment 310 may be rearranged into segment 320 and segment 320 may be provided to complex modulators 520A-520C. Thus, bit stream segmentation and distribution component 510 may provide bits B₈-B₁₁ to first complex modulator 520A, bits B₄-B₇ to second complex modulator 520B, and bits B₀-B₃ to third complex modulator 520C.

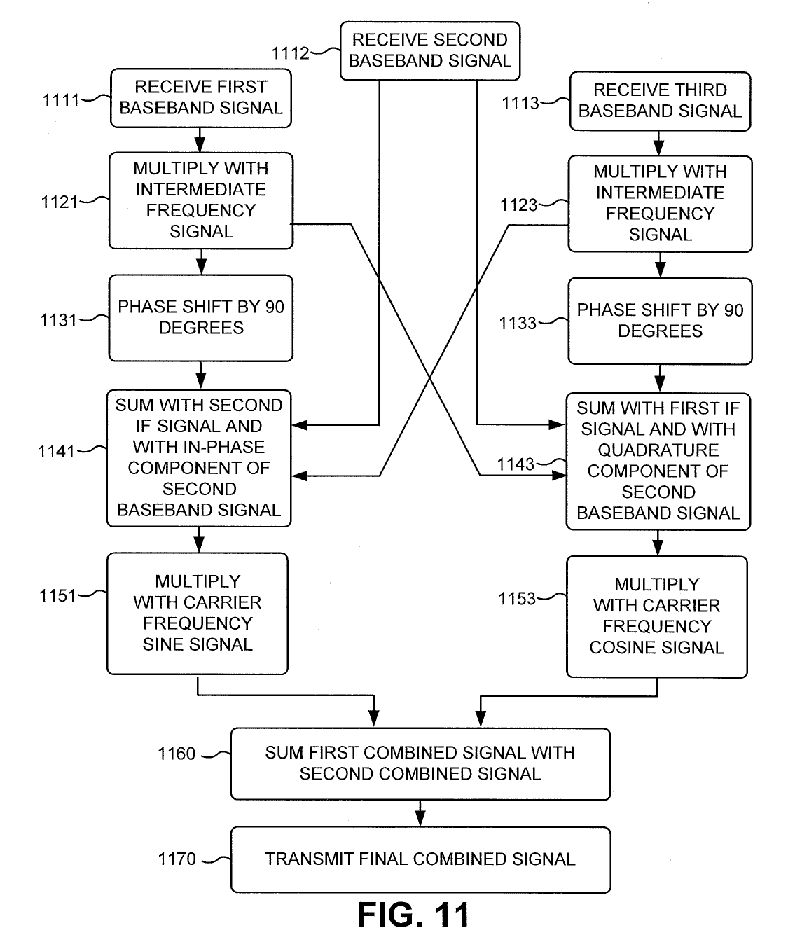

FIG. 11 illustrates a flow graph of an exemplary process for transmitting a signal. In one implementation, the process of FIG. 11 may be performed by RF transmitter 600. In other implementations, some or all of the process of FIG. 11 may be performed by another device or a group of devices.

The process of FIG. 11 may include receiving a first baseband signal (block 1111), receiving a second baseband signal (block 1112), and receiving a third baseband signal (block 1113). For example, transmitter 600 may receive first baseband signal S_{A} 530A, second baseband signal S_{B} 530B, and third baseband signal S_{C} 530C.

The first and third signals may be multiplied with an IF signal to generate a first IF signal and a second IF signal, respectively (block 1121 and 1123). For example, first transmitter section 600A may multiply the I component of first baseband signal S_{A} 530A with cos(ω_{IF}t), using cosine mixer 610A, and may multiply the Q component of first baseband signal S_{A} 530A with sin(ω_{IF}t), using sine mixer 620A to generate first IF signal S_{A} 640A, and second transmitter section 600B may multiply the I component of third baseband signal S_{C} 530C with cos(ω_{IF}t), using cosine mixer 610C, and may multiply the Q component of third baseband signal S_{C} 530C with sin(ω_{IF}t), using sine mixer 620C to generate second IF signal S_{C} 640C.

The first and second IF signals may be phase shifted by 90 degrees (block 1131 and 1133). For example, RF transmitter section 600C may shift first IF signal S_{A} 640A by 90 degrees, using first shifter 650A, and may shift second IF signal S_{C} 640C by 90 degrees, using second shifter 650C.

The shifted first IF signal may be summed with the un-shifted second IF signal and with the in-phase component of the second baseband signal to generate a first combined signal (block 1141), and the shifted second IF signal may be summed with the un-shifted first IF signal and with the quadrature component of the second baseband signal to generate a second combined signal (block 1143). For example, RF transmission section 600C may sum shifted first IF signal S_{A} 640A with un-shifted second IF signal S_{C} 640C and with the I component of second baseband signal S_{B} 530B, using first summer 660A, and may sum shifted second IF signal S_{C} 640C with un-shifted first IF signal S_{A} 640A and with the Q component of second baseband signal S_{B} 530B, using second summer 660C.

The first combined signal may be multiplied with a carrier frequency sine signal (block 1151) and the second combined signal may be multiplied with a carrier frequency cosine signal (block 1153). For example, RF transmission section 600C may multiply the first combined signal with sin(ω₀t), using sine mixer 670A, and may multiply the second combined signal with cos(ω₀t), using cosine mixer 670C.

The first combined signal and the second combined signal may be summed to generate a final combined multi-frequency signal (block 1160). For example, RF transmission section 600C may sum the first combined signal and the second combined signal to generate a final combined multi-frequency signal 685, using third summer 680. The final combined multi-frequency signal may be transmitted (block 1170). For example, RF transmission section 600C may amplify combined multi-frequency signal 685 and provide the amplified signal to antenna assembly 450 for transmission.

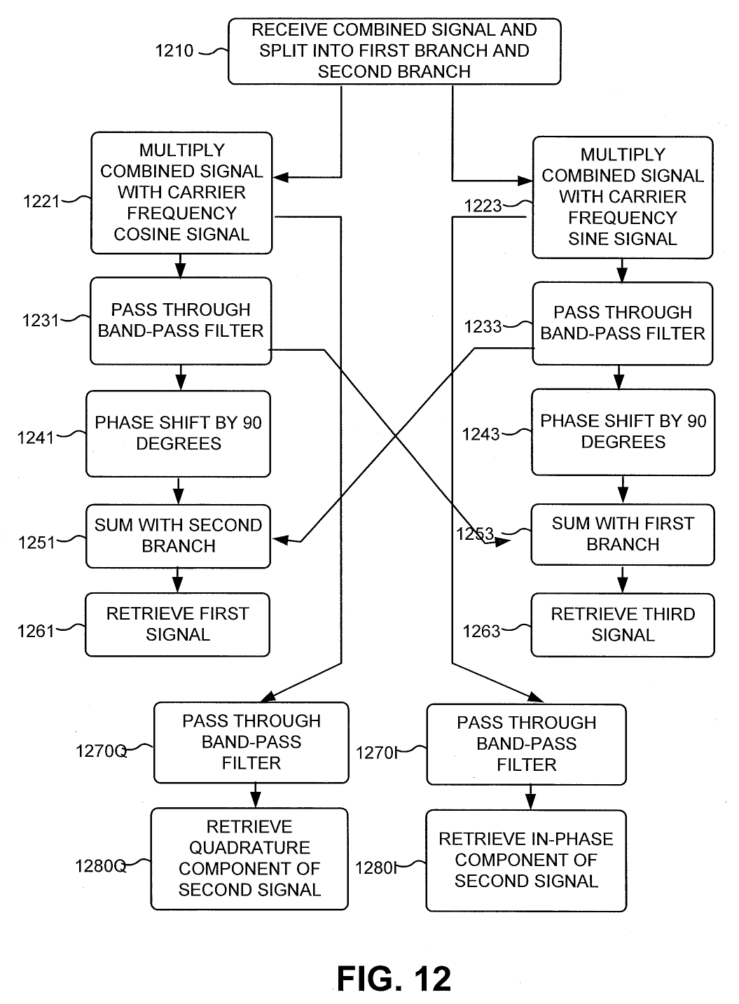

FIG. 12 illustrates a flow graph of an exemplary process for receiving a signal. In one implementation, the process of FIG. 12 may be performed by RF receiver 700. In other implementations, some or all of the process of FIG. 12 may be performed by another device or a group of devices.

The process of FIG. 12 may include receiving a combined signal and splitting the combined signal into a first branch signal and a second branch signal (block 1210). The first branch signal may be multiplied with a carrier frequency cosine signal (block 1221) and the second branch signal may be multiplied with a carrier frequency sine signal (block 1223). For example, RF receiver section 700A may receive combined multi-frequency signal 685, split combined multi-frequency signal 685 into a first branch that is multiplied by cos(ω₀t), using cosine mixer 730A, and a second branch that is multiplied by sin(ω₀t), using sine mixer 730C.

The first branch signal may be passed through a band-pass filter (block 1231) and the second branch signal may be passed through a band-pass filter (block 1233). For example, RF receiver section 700A may pass the first branch signal through first filter 740A and may pass the second branch signal through second filter 740C.

The first branch signal may be phase shifted by 90 degrees (block 1241) and the second branch signal may be phase shifted by 90 degrees (block 1243). For example, RF receiver section 700A may shift the first branch signal using first shifter 750A and may shift the second branch signal using second shifter 750C.

The shifted first branch signal may be summed with the un-shifted second branch signal (block 1251) and the shifted second branch signal may be summed with the un-shifted first branch signal (block 1253). For example, RF receiver section 700A may sum the shifted first branch with the un-shifted second branch, using first summer 760A, and RF receiver section 700A may sum the shifted second branch with the un-shifted first branch, using second summer 760C.

A first signal may be retrieved from the summed shifted first branch signal and un-shifted second branch signal (block 1261). For example, RF transmitter section 700A may retrieve first IF signal S_{A} 640A from the summed shifted first branch signal and un-shifted second branch signal and provide first IF signal S_{A} 640A to first IF transmitter section 700B.

A third signal may be retrieved from the summed shifted second branch signal and un-shifted first branch signal (block 1261). For example, RF transmitter section 700A may retrieve second IF signal S_{C} 640C from the summed shifted second branch signal and un-shifted first branch signal and provide second IF signal S_{C} 640C to second IF transmitter section 700C.

The first branch signal multiplied with the carrier frequency sine signal (from block 1221) may be passed through band-pass filter (block 1270Q) and the second branch signal multiplied with the carrier frequency cosine signal (from block 1223) may be passed through band-pass filter (block 12701). For example, RF transmitter section 700A may pass the first branch signal multiplied with the carrier frequency sine signal through third filter 7401 and may pass the second branch signal multiplied with the carrier frequency cosine signal through fourth filter 740Q.

A quadrature component of a second signal may be retrieved (block 1280Q) and an in-phase component of the second signal may be received (block 12801). For example, RF transmitter section 700A may retrieve an I component of second baseband signal S_{B} 530B from the output of third filter 7401 and may retrieve a Q component of second baseband signal S_{B} 530B from the output of fourth filter 740Q.

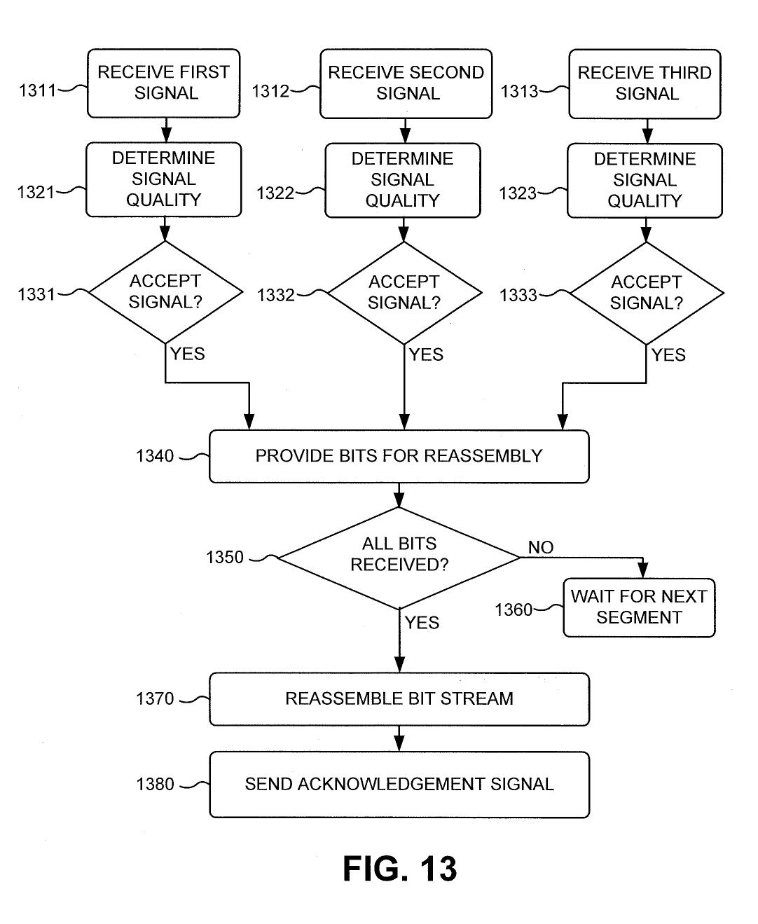

FIG. 13 illustrates a flow graph of a first exemplary process for re-assemblying a bit stream from a received signal. In one implementation, the process of FIG. 13 may be performed by baseband controller 442 of receiver device 130. In other implementations, some or all of the process of FIG. 13 may be performed by another device or a group of devices. In the process of FIG. 13, a quality of received signals may be analyzed separately for each received signal.

The process of FIG. 13 may include receiving a first signal (block 1311), receiving a second signal (block 1312), and receiving a third signal (block 1313). For example, signal quality analyzer 810A may receive first baseband signal S_{A} 530A, signal quality analyzer 810B may receive second baseband signal S_{B} 530B, and signal quality analyzer 810C may receive third baseband signal S_{C} 530C.

A signal quality of the received first signal may be determined (block 1321), a signal quality of the received second signal may be determined (block 1322), and a signal quality of the received first signal may be determined (block 1323). For example, signal quality analyzer 810A may compute a SNR value for received first baseband signal S_{A} 530A, signal quality analyzer 810C may compute a SNR value for received second baseband signal S_{B} 530B, and signal quality analyzer 810C may compute a SNR value for received third baseband signal S_{C} 530C.

If the determined signal quality of the first received signal is above a particular threshold, the first signal may be accepted (block 1331). If the determined signal quality of the second received signal is above a particular threshold, the second signal may be accepted (block 1332). If the determined signal quality of the third received signal is above a particular threshold, the third signal may be accepted (block 1333).

Bits may be provided for reassembly (block 1340). For example, bit stream reassembly component 830 may receive one or more signals that were accepted. A determination may be made whether all bits were received (block 1350). For example, bit stream reassembly component 830 may determine whether all 12 bits of bit stream 505 have been received. If it is determined that not all bit streams have been received (block 1350—no), waiting may occur to receive the next segment (block 1360). For example, bit stream reassembly component 830 may wait to receive the next segment of bit stream 505 (e.g., second segment 320).

If it is determined that all bits have been received, the bit stream may be reassembled (block 1370). For example, bit stream reassembly component 830 may reassemble bit stream 505 from the received signals, or from a combination of the received signals and previously received signals. An acknowledgement signal may be sent (block 1380). For example, bit stream reassembly component 830 may send acknowledgement signal 590 to transmitter device 110 to indicate that all of bit stream 505 has been received.

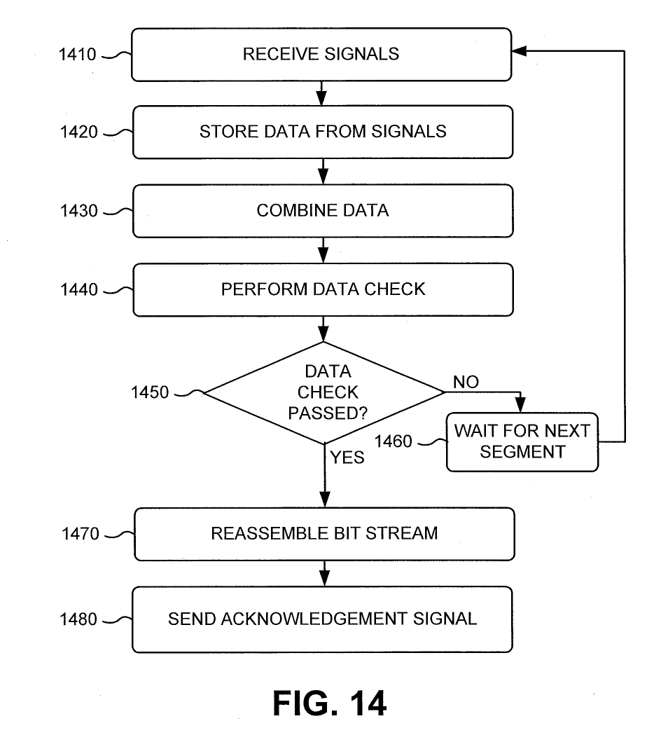

FIG. 14 illustrates a flow graph of a second exemplary process for reassemblying a bit stream from a received signal. In one implementation, the process of FIG. 14 may be performed by baseband controller 442 of receiver device 130. In other implementations, some or all of the process of FIG. 14 may be performed by another device or a group of devices. In the process of FIG. 14, data from received signals may be combined and a data check may be performed on the combined data.

The process of FIG. 14 may include receiving signals (block 1410). For example, bit stream reassembly component 830 may receive first baseband signal S_{A} 530A, second baseband signal S_{B} 530B, and third baseband signal S_{C} 530C. Data from the received signals may be stored (block 1420). For example, bit stream reassembly component 830 may store data from first baseband signal S_{A} 530A, second baseband signal S_{B} 530B, and third baseband signal S_{C} 530C in a temporary register.

The stored data may be combined (block 1430). For example, bit stream reassembly component 830 may combine the stored data, or may combine the stored data with previously stored data from previously received segments in different combinations. Previous segments may have been previously stored received and stored. Bit stream reassembly component 830 may try to combine the stored data and/or the previously stored data in different combination in an attempt to reconstruct a message in its entirety.

For example, if previously stored data from a first segment includes {D(A₁), D(B₁), D(C₁)} and data from a second segment includes {D(A₂), D(B₂), D(C₂)}, the stored data may be combined in any of the following 7 additional combinations to reconstruct the message: {D(A₁), D(B₁), D(C₂)}, {D(A₁), D(B₂), D(C₁)}, {D(A₁), D(B₂), D(C₂)}, {D(A₂), D(B₁), D(C₁)}, {D(A₂), D(B₁), D(C₂)}, {D(A₂), D(B₂), D(C₁)} or {D(A₂), D(B₂), D(C₂)}. If two segments were previously received and a third segment has been received, the stored data may be combined in 3×3=27 combinations (of which 8 have been previously tested).

A data check may be performed on the combined data (block 1440). For example, bit stream reassembly component 830 may perform a CRC, or use another type of hash function or data checking technique, on a particular combination of the data. In one implementation, data checks may be performed on all possible combinations of data. In another implementation, data checks may be performed on particular combinations of data in sequence, until a particular combination passed the data check, at which point no further combinations may be checked.

A determination may be made as to whether the data check passed (block 1450). For example, bit stream reassembly component may compare the computed CRC to a previously computed CRC for the bit stream. For example, transmitter device 110 may provide a previously computed CRC for the data in a header associated with bit stream 505. If the two CRC values match, the data check may pass. Additionally, FEC may be performed to correct errors if the data check did not pass.

If it determined that the data check did not pass (block 1450—no), waiting may occur for a next segment (block 1460) and processing may return to block 1410. For example, bit stream reassembly component 830 may wait to receive the next segment. If it is determined that the data check did pass (block 1450—yes), the bit stream may be reassembled (block 1470). For example, bit stream reassembly component 830 may reassemble bit stream 505 from the received signals, or from a combination of the received signals and previously received signals, which has passed the data check. An acknowledgement signal may be sent (block 1380). For example, bit stream reassembly component 830 may send acknowledgement signal 590 to transmitter device 110 to indicate that all of bit stream 505 has been successfully received.

### CONCLUSION

The foregoing description provides illustration and description, but is not intended to be exhaustive or to limit the invention to the precise form disclosed. Modifications and variations are possible in light of the above teachings or may be acquired from practice of the invention.

For example, while implementations described herein have been described using three frequencies, fewer than three or more than three frequencies may be used. For example, transmitter device 110 and receiver device 130 may be scaled up to incorporate additional frequencies.

As another example, while series of blocks have been described with respect to FIGS. 10-13, the order of the blocks may be modified in other implementations. Further, non-dependent blocks may be performed in parallel.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit disclosure of the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A system, comprising:
a receiver device that includes:
a radio frequency (RF) receiver to:
receive a multi-frequency signal, and
retrieve a plurality of baseband signals from the received multi-frequency signal, where each of the plurality of baseband signals is associated with a different frequency; and
a baseband controller to:
receive the plurality of baseband signals and reassemble a bit stream of information from the plurality of baseband signals.

2. The system of claim 1, where the multi-frequency signal includes a first signal at a carrier frequency minus an intermediate frequency (IF), a second signal at the carrier frequency, and a third signal at the carrier frequency plus the IF.

3. The system of claim 2, where the RF receiver is further to:
retrieve the first signal at the IF,
retrieve an in-phase component and a quadrature component of the second signal, and
retrieve the third signal at the IF.

4. The system of claim 2, where the RF receiver is to split the received multi-frequency signal into a first branch signal and a second branch signal, and where the RF receiver includes:
a first mixer to mix the first branch signal with a cosine signal at the carrier frequency,
a second mixer to mix the second branch signal with a sine signal at the carrier frequency,
a first shifter to shift the mixed first branch signal;
a second shifter to shift the mixed second branch signal;
a first summer to sum the shifted first branch signal and an un-shifted second branch signal to retrieve the first signal; and
a second summer to sum the shifted second branch signal and an un-shifted first branch signal to retrieve the third signal.

5. The system of claim 4, where the RF receiver is further to:
retrieve an in-phase component of the second signal from the mixed first branch signal, and
retrieve a quadrature component of the second signal from the mixed second branch signal.

6. The system of claim 1, where the baseband controller is to determine a measure of quality for a particular one of the plurality of baseband signals and reject the particular one of the plurality of baseband signals if the measure of quality of the particular one of the plurality of baseband signals is below a particular threshold.

7. The system of claim 1, where the plurality of baseband signals includes a bit stream of information, where a particular one of the plurality of baseband signals includes a section of the bit stream of information, and where another one of the plurality of baseband signals includes a different section of the bit stream of information.

8. The system of claim 7, where the baseband controller is to receive a subsequent plurality of baseband signals that includes the bit stream of information, where the subsequent plurality of baseband signals includes a different arrangement of bits of the bit stream of information.

9. The system of claim 1, further comprising a transmitter device that includes:
another baseband controller to:
segment information to be transmitted into a plurality of segments,
generate a first plurality of transmission baseband signals that includes the plurality of segments, where a particular one of the plurality of first transmission baseband signals includes a particular one of the plurality of segments,
generate a second plurality of transmission baseband signals that includes the plurality of segments, where an arrangement of the plurality of segments included in the second plurality of transmission baseband signals differs from an arrangement of the plurality of segments includes in the first plurality of transmission baseband signals.

10. The system of claim 9, where the transmitter device further includes:
an RF transmitter to generate a first transmission multi-frequency signal from the first plurality of transmission baseband signals and a second transmission multi-frequency signal from the second plurality of transmission baseband signals.

11. The system of claim 10, where the RF transmitter includes:
a first shifter to shift a first transmission IF signal;
a second shifter to shift a second transmission IF signal;
a first summer to sum the shifted first transmission IF signal, an un-shifted second transmission IF signal, and a quadrature component of a second baseband signal to generate a first summed signal;
a first mixer to mix the first summed signal with a sine carrier frequency signal;
a second summer to sum the shifted second transmission IF signal, an un-shifted first transmission IF signal, and an in-phase component of the second baseband signal to generate a second summed signal;
a second mixer to mix the second summed signal with a cosine carrier frequency signal; and
a third summer to sum the mixed first summed signal with the mixed second summed signal to generate the first transmission multi-frequency signal.

12. The system of claim 9, where the receiver device is to send an acknowledgement signal to the transmitter device in response to receiving the information.

13. A method performed by a radio frequency receiver device, the method comprising:
receiving a multi-frequency signal;
retrieving a plurality of baseband signals from the received multi-frequency signal;
retrieving particular segments of bits from particular ones of the plurality of baseband signals; and
reassembling a bit stream of information from the retrieved segments of bits.

14. The method of claim 13, where the multi-frequency signal includes a first signal at a carrier frequency minus an intermediate frequency (IF), a second signal at the carrier frequency, and a third signal at the carrier frequency plus the IF.

15. The method of claim 14, where the retrieving a plurality of baseband signals from the received multi-frequency signal includes:
retrieving the first signal at the IF,
retrieving an in-phase component and a quadrature component of the second signal, and
retrieving the third signal at the IF.

16. The method of claim 13, where the retrieving a plurality of baseband signals from the received multi-frequency signal comprises:
splitting the received multi-frequency signal into a first branch signal and a second branch signal;
mixing the first branch signal with a cosine signal at a carrier frequency,
mixing the second branch signal with a sine signal at the carrier frequency,
shifting the mixed first branch signal;
shifting the mixed second branch signal;
summing the shifted first branch signal and an un-shifted second branch signal to retrieve a first signal; and
summing the shifted second branch signal and an un-shifted first branch signal to retrieve a third signal.

17. The method of claim 16, further comprising:
retrieving an in-phase component of a second signal from the mixed first branch signal, and
retrieving a quadrature component of the second signal from the mixed second branch signal.

18. The method of claim 12, where reassembling the bit stream of information comprises:
determining a quality of a particular one of the plurality of baseband signals; and
rejecting the particular one of the plurality of baseband signals, if the determined quality is below a particular threshold.

19. The method of claim 12, further comprising:
transmitting an acknowledgement signal to a transmitter device, indicating that the bit stream of information was received.

20. A system comprising:
a transmitter device that includes:
a transmitter baseband controller to:
segment a bit stream into a first segment, a second segment, and a third segment, and
generate a first baseband signal that includes the first segment, a second baseband signal that includes the second segment, and a third baseband signal that includes the third segment; and
a radio frequency (RF) transmitter to:
generate a multi-frequency signal based on the first baseband signal, the second baseband signal, and the third baseband signal; and
a receiver device that includes:
an RF receiver to:
receive the multi-frequency signal, and
retrieve the first baseband signal, the second baseband signal, and the third baseband signal from the received multi-frequency signal; and
a receiver baseband control to:
reassemble the bit stream from the received first baseband signal, the received second baseband signal, and the received third baseband signal.
